(19) United States
(12) Patent Application Publication
(10) Pub. No.: US 2013/0064433 A1
(43) Pub. Date: Mar. 14, 2013

(54) ELECTRONIC DEVICE AND TURNING ON OR UNLOCKING METHOD

(71) Applicant: CHING-CHUNG WU, Tu-Cheng (TW)

(72) Inventor: CHING-CHUNG WU, Tu-Cheng (TW)

(73) Assignee: HON HAI PRECISION INDUSTRY CO., LTD., Tu-Cheng (TW)

(21) Appl. No.: 13/450,497

(22) Filed: Apr. 19, 2012

(30) Foreign Application Priority Data
Sep. 13, 2011 (TW) 100132785

(51) Int. Cl. G06K 9/46

(52) U.S. Cl. 382/118

(57) ABSTRACT

The present disclosure provides an electronic device and a method of turning on or unlocking an electronic device. The method includes steps: controlling the capturing unit to capture a predetermined number of facial images in response to an input for turning on or unlocking the electronic device. Acquiring a clear facial image from the predetermined number of facial images. Performing an image processing for the clear facial image to obtain a facial feature of the clear facial image; and if there is one facial feature in the stored at least one facial image matching with the facial feature of the clear facial image in the storage unit, turning on or unlocking the electronic device.

### BACKGROUND

1. Technical Field

The present disclosure relates to electronic devices and, particularly, to an electronic device and a method of turning on or unlocking the device.

2. Description of Related Art

A user often inputs a password to turn on or unlock an electronic device. However, the password is easily hacked or stolen by an illegal user, leading to data of legal users going missing.

Therefore, what is needed is an electronic device and a method of turning on or unlocking the device to overcome the described limitations.

### BRIEF DESCRIPTION OF THE DRAWINGS

FIG. 1 is a block diagram of the hardware infrastructure of an electronic device, in accordance with an exemplary embodiment.

FIG. 2 is a block diagram of the processing unit of the electronic device of FIG. 1, in accordance with an exemplary embodiment.

FIG. 3 is a flowchart of a method of turning on or unlocking the electronic device of FIG. 1, in accordance with an exemplary embodiment.

### DETAILED DESCRIPTION

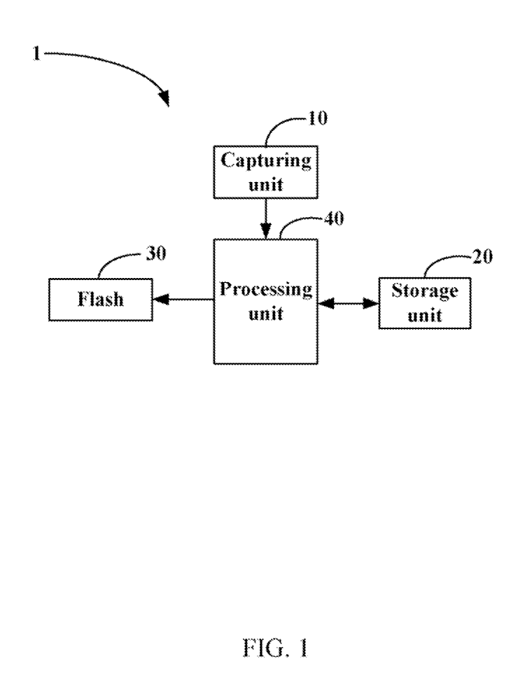

FIG. 1 is a block diagram of the hardware infrastructure of an electronic device, in accordance with an exemplary embodiment. The electronic device 1 may be a mobile phone, or a computer, for example. The electronic device 1 includes a processing unit 40, a capturing unit 10, and a storage unit 20. The capturing unit 10 captures facial images. In one embodiment, the capturing unit 10 is a camera. The storage unit 20 stores at least one facial image and a facial feature of the facial image. In one embodiment, the at least one facial image is the facial image of authorized users. The at least one facial image is obtained from an external device (not shown) or the capturing unit 10.

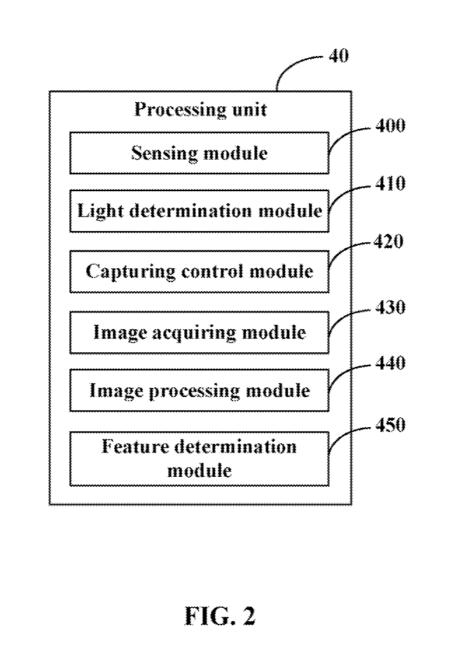

As shown in FIG. 2, the processing unit 40 includes a capturing control module 420, an image acquiring module 430, an image processing module 440, and a feature determination module 450.

The capturing control module 420 controls the capturing unit 10 to capture a predetermined number of facial images in response to an input for turning on or unlocking the electronic device 1. In one embodiment, the capturing control module 420 controls the capturing unit 10 to successively capture a predetermined number of facial images in response to input from a user to turn on or unlock the electronic device 1.

The image acquiring module 430 acquires a clear facial image from the predetermined number of facial images. In one embodiment, the image acquiring module 430 acquires a facial image having facial contours the same as the clear facial image.

The image processing module 440 performs an image processing for the clear facial image to obtain a facial feature. The facial feature reflects the characters of a the face of a user, a birthmark, a nose, a shape of a face, for example. The feature determination module 450 determines whether there is one matched facial feature in the storage unit 20 matching with the facial feature of the clear facial image. When there is one matched facial image in the storage unit 20, the user is legal, and the feature determination module 450 turns on or unlocks the electronic device 1. When there is no matched facial image in the storage unit 20, the user is illegal, and the electronic device 1 is not turned on or unlocked. Therefore, only a legal user can use and operate the electronic device 1.

Furthermore, the storage unit 20 stores the parameters of each facial feature. For example, the parameters may include a size of a birthmark, a size of a nose, a shape of a face, for example. The feature determination module 450 analyzes the facial feature of the clear facial image to obtain the parameters of the facial feature of the clear facial image and compare the parameters of the facial feature with the parameters of the stored facial image. When all differences between the parameters of the clear facial image and the parameters of the stored facial image are within a predefined range, the feature determination module 450 determines that there is one matched facial image in the storage unit 20 and turns on or unlocks the electronic device 1.

In addition, the capturing control module 420 further controls the capturing unit 10 to capture the predetermined number of facial images again when there is no facial image in the storage unit 20 matching with the clear facial image.

Additionally, the electronic device 1 further includes a flash 30. The processing unit 40 further includes a sensing module 400 and a light determination module 410. The sensing module 400 senses a level of ambient light surrounding the electronic device 1. The light determination module 410 controls the sensing module 400 to sense the level of ambient light before the capturing unit 10 captures the facial images and determines whether the level of the ambient light is sufficient. If the level of the ambient light is not sufficient, the flash 30 is turned on. If the level of the ambient light is sufficient, the capturing unit 10 captures the facial images.

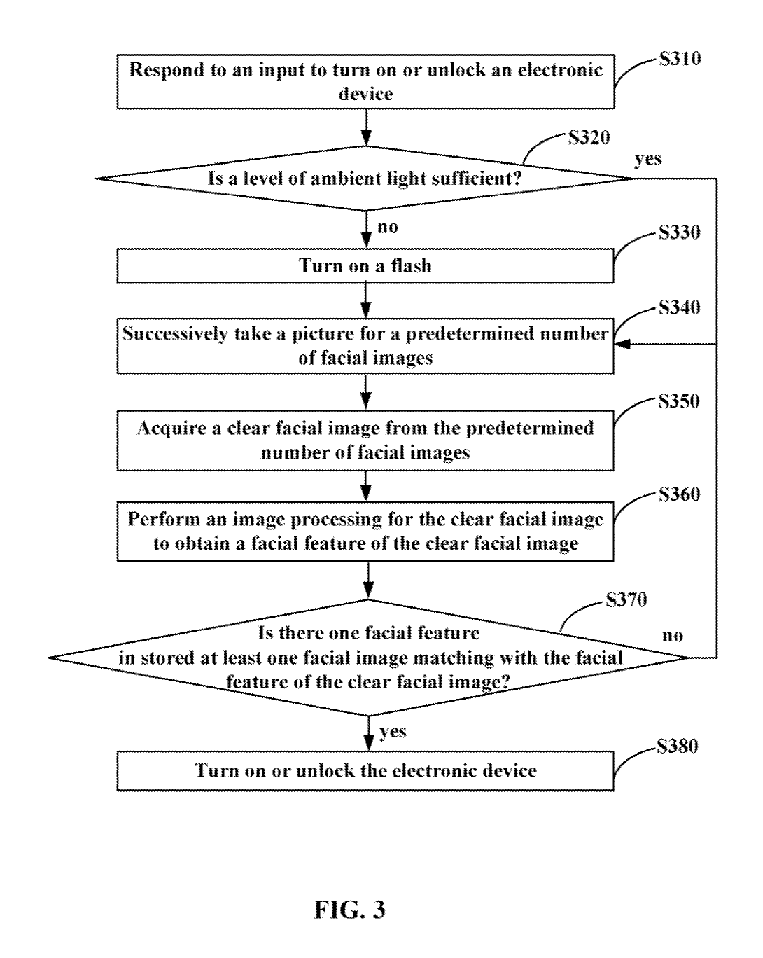

FIG. 3 is a flowchart of a method of turning on or unlocking the electronic device of FIG. 1, in accordance with an exemplary embodiment.

In step S310, the electronic device 1 responds to an input from a user to turn on or unlock the electronic device 1.

In step S320, the sensing module 400 senses a level of ambient light surrounding the electronic device 1 and the light determination module 410 determines whether the level of the ambient light is sufficient.

In step S330, if the level of the ambient light is not sufficient, the flash 30 is turned on. If the level of the ambient light is sufficient, the step goes on S340.

In step S340, the capturing control module 420 controls the capturing unit 10 to successively capture a predetermined number of facial images.

In step S350, the image acquiring module 430 acquires a clear facial image from the predetermined number of facial images.

In step S360, the image processing module 440 performs an image processing for the clear facial image to obtain a facial feature of the clear facial image.

In step S370, the feature determination module 450 determines whether there is one facial feature in the storage unit 20 matching with the facial feature of the clear facial image.

In step S380, If there is one matched facial image in the storage unit 20, the feature determination module 450 turns on or unlocks the electronic device 1. If there is no matched facial image in the storage unit 20, the step returns to S340, the capturing control module 420 further controls the capturing unit 10 to capture the predetermined number of facial images again.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a capturing unit to capture facial images;
a storage unit to store at least one facial image and a facial feature of each of the at least one facial image; and
a processing unit comprising:
a capturing control module to control the capturing unit to capture a predetermined number of facial images in response to an input from a user to turn on or unlock the electronic device;
an image acquiring module to acquire a clear facial image from the predetermined number of facial images;
an image processing module to perform an image processing for the clear facial image to obtain a facial feature of the clear facial image; and
a feature determination module to determine whether there is one facial feature of the stored at least one facial image in the storage unit matching with the facial feature of the clear facial image, and turn on or unlock the electronic device when there is one matched facial image in the storage unit.

2. The electronic device as described in claim 1, wherein the image acquiring module is to acquire a facial image having facial contours the same as the clear facial image.

3. The electronic device as described in claim 1, wherein the storage unit is configured to store the parameters of each facial feature and the feature determination module is configured to analyze the facial feature of the clear facial image to obtain the parameters of the facial feature of the clear facial image and compare the parameters of the facial feature of the clear facial image with the parameters of the stored at least one facial image, when all differences between the parameters of the clear facial image and the parameters of the stored at least one facial image are within a predefined range, there is one matched facial image in the storage unit.

4. The electronic device as described in claim 1, wherein the at least one facial image is the facial image of authorized users.

5. The electronic device as described in claim 1, wherein the capturing control module is further to control the capturing unit to capture the predetermined number of facial images again when there is no facial image in the storage unit matching with the clear facial image.

6. The electronic device as described in claim 1, further comprising a flash, wherein the processing unit further comprises a sensing module and a light determination module, the sensing module is to sense the level of ambient light surrounding the electronic device, the light determination module is to control the sensing module to sense the level of ambient light before the capturing unit captures the facial images and determine whether the level of the ambient light is sufficient, and to turn on the flash when the level of the ambient light is not sufficient.

7. The electronic device as described in claim 1, wherein the capturing control module is to control the capturing unit to successively capture a predetermined number of facial images in response to an input from the user to turn on or unlock the electronic device.

8. A method of turning on or unlocking an electronic device, the electronic device comprising a capturing unit and a storage unit to store at least one facial image and a facial feature of each of the at least one facial image, the method comprising:
controlling the capturing unit to capture a predetermined number of facial images in response to an input from a user to turn on or unlock the electronic device;
acquiring a clear facial image from the predetermined number of facial images;
performing an image processing for the clear facial image to obtain a facial feature of the clear facial image; and
if there is one facial feature of the stored at least one facial image in the storage unit matching with the facial feature of the clear facial image, turning on or unlocking the electronic device.

9. The method as described in claim 8, the step “acquiring a clear facial image from the predetermined number of facial images” comprising:
acquiring a facial image having facial contours the same as the clear facial image.

10. The method as described in claim 8, wherein the storage unit is configured to store the parameters of each facial feature, further comprising:
analyzing the facial feature of the clear facial image to obtain the parameters of the facial feature of the clear facial image;
comparing the parameters of the facial feature of the clear facial image with the parameters of the stored at least one facial image; and
when all differences between the parameters of the clear facial image and the parameters of the stored at least one facial image are within a predefined range, there is one matched facial image in the storage unit.

11. The method as described in claim 8, wherein the at least one facial image is the facial image of authorized users.

12. The method as described in claim 8, further comprising:
controlling the capturing unit to capture the predetermined number of facial images again when there is no facial image in the storage unit matching with the clear facial image.

13. The method as described in claim 8, wherein the electronic device comprises a flash, further comprising:
sensing a level of ambient light surrounding the electronic device before the capturing unit captures the facial images; and
turning on the flash when the level of the ambient light is not sufficient.

14. The method as described in claim 8, further comprising:
successively capturing a predetermined number of facial images in response to an input from the user to turn on or unlock the electronic device.
